(19) United States
(12) Patent Application Publication
(10) Pub. No.: US 2014/0008548 A1
(43) Pub. Date: Jan. 9, 2014

(54) WEATHERING TEST AT DIFFERENT UV WAVELENGTHS OF UV LIGHT EMITTING DIODES

(71) Applicant: ATLAS MATERIAL TESTING TECHNOLOGY GmbH, Linsengericht-Altenhasslau (DE)

(72) Inventors: Bernd RUDOLPH, Alzenau (DE); Peter MARCH, Frankfurt am Main (DE)

(21) Appl. No.: 13/934,918

(22) Filed: Jul. 3, 2013

(30) Foreign Application Priority Data
Jul. 5, 2012 (EP) 12 175187.9

(51) Int. Cl. G01N 1/44

(52) U.S. Cl. CPC G01N 1/44
USPC 250/455.11

(57) ABSTRACT

A device has a weathering chamber, in which a UV radiation device is arranged and at least one sample can be arranged. The UV radiation device has a plurality of UV light emitting diodes (UV LEDs) containing UV LEDs of different emission bands. The UV LEDs can be driven in such a way that in each case UV LEDs of a specific emission band can be switched on and off jointly, independently of UV LEDs of the other emission bands. In the method, at least one sample is irradiated with radiation from at least one UV LED of a specific emission band and variations of the sample on account of the irradiation are subsequently analyzed.

### CROSS REFERENCE TO RELATED APPLICATIONS

This application is based on and hereby claims priority to European Patent Application No. 12 175 187.9 filed on Jul. 5, 2012, the contents of which are hereby incorporated by reference.

### BACKGROUND

The present invention relates to a method for artificially weathering or testing the lightfastness of samples, and to a device for artificially weathering or testing the lightfastness of samples.

In devices for artificial weathering, an assessment of the weather-governed aging behavior of a sample, in particular of a planar material sample, is carried out, wherein the sample is subjected to artificial weathering. Such devices usually comprise for this purpose a weathering chamber, in which mounting means for the mounting of samples to be weathered and a radiation source for applying radiation, in particular UV radiation, to the samples are arranged.

In such devices for artificially weathering or testing the lightfastness of material samples, the intention usually is to estimate the service life of materials which, in the application thereof, are constantly exposed to natural weather conditions and thus deteriorate under climatic influences such as sunlight, heat from the sun, moisture and the like. In order to obtain a good simulation of the natural weather circumstances, it is advantageous if the spectral energy distribution of the light generated in the device corresponds as much as possible to that of the natural solar radiation, for which reason xenon emitters have been used as radiation source hitherto in such devices. In addition, a time-lapse aging test of the materials is substantially obtained by the samples being irradiated in a manner greatly intensified relative to the natural conditions, whereby the aging of the samples is accelerated. Consequently, after a comparatively short time it is possible to make a statement about the long-term aging behavior of a material sample.

The material samples examined in artificial weathering devices for the most part consist of polymeric materials. In the latter, the weather-governed deterioration is substantially brought about by the UV component of the solar radiation. The photochemical primary processes that take place here, that is to say the absorption of photons and the generation of excited states or free radicals, are temperature-independent. By contrast, the subsequent reaction steps with the polymers or additives can be temperature-dependent, with the result that the observed aging of the materials is likewise temperature-dependent.

In the weathering test devices known hitherto, a xenon lamp is usually used as radiation source. Although, as is known, the solar spectrum can be simulated very well with this lamp, the emitted radiation has a relatively high spectral component in the infrared spectral range, which has to be suppressed by filters in order to prevent the samples from being heated to an excessively great extent. Moreover, a commercially available xenon radiation source has only a service life of approximately 1500 ours.

Furthermore, a metal halide lamp can also be used as radiation source, but this lamp has the disadvantage that it cannot be regulated, or can be regulated only with great difficulty. The same also applies to fluorescent lamps, which have likewise already been used as radiation sources in weathering test devices and are disadvantageously associated with a relatively short service life.

A further disadvantage of the above-mentioned conventional radiation sources of weathering test devices is that the latter are relatively unwieldy in accordance with their construction and their driving and therefore cannot be adapted for example to changed conditions with regard to the sample surfaces of the material samples to be irradiated.

### SUMMARY

It is therefore an object of the present invention to specify a method for artificially weathering or testing the lightfastness of samples and a device for artificially weathering or testing the lightfastness of samples with which the effect of the UV radiation can be analyzed better in a spectral regard.

This object is achieved by means of the features of the independent patent claims. Dependent claims relate to advantageous developments and configurations.

An essential insight of the present invention is that in many material samples to be examined, the aging behavior or the change in lightfastness in the case of UV irradiation depends not only on the intensity but also on the spectral characteristic of the UV radiation. Samples composed of organic material, in particular, usually have a light sensitivity that exhibits a significant dependence on the photon energy of the UV radiation. In order to improve the analysis, it may thus prove to be advantageous to afford a possibility of being able to carry out the irradiation at one or more specific wavelengths or emission bands of the UV spectrum.

The invention is described below on the basis of a method for artificially weathering or testing the lightfastness of samples in accordance with a first aspect, a device for artificially weathering or testing the lightfastness of samples in accordance with a second aspect, and a UV radiation device in accordance with a third aspect. It should be pointed out that all features or details described only in connection with one subject of these three aspects can also be applied to the subjects of the other two aspects.

A method according to the invention for artificially weathering or testing the lightfastness of samples in accordance with a first aspect accordingly comprises the following steps:
a. Providing a weathering chamber, which contains a UV radiation device comprising UV light emitting diodes (UV LED) of different emission bands;
b. Arranging at least one sample in the weathering chamber at a distance from the UV LEDs;
c. Irradiating the sample with radiation from at least one UV LED of a specific emission band;
d. Analyzing the variations of the sample on account of the irradiation.

In accordance with one embodiment of the method according to the invention, steps c. and d. can be carried out for one or more further emission bands by the sample being irradiated with UV light from the corresponding UV LEDs.

In accordance with one embodiment of the method according to the invention, the UV radiation device has for each emission band a class having a plurality of UV LEDs. The UV LEDs of an emission band can then be arranged in such a way and/or driven in such a way that in the region of the at least one sample a positionally dependent variation of the radiation intensity lies within predefined limits. Accordingly, a number of, for example three or more, classes of UV LEDs of different emission bands can be present within the UV radiation device. In this case, it can be provided that in each class the UV LEDs are arranged in a manner distributed spatially uniformly on an area. In this case, the UV LEDs can be driven in such a way that they emit UV radiation having an identical radiation power. If the sample plane is spaced apart far enough from the plane of the UV LEDs, then the superimposition of adjacent UV radiation cones in the region of the sample plane has the effect that the radiation intensity along the sample plane is not subjected to significant fluctuations. However, it may also be the case that the UV LEDs of at least one class cannot be arranged with sufficient spatial uniformity on an area. In this case it may be that, during operation with identical radiation powers of each of the UV LEDs of the class, an excessively large positionally dependent variation of the radiation intensity in the sample plane occurs. If this variation exceeds a predefined threshold value, then it can be provided, for example, that the UV LEDs of this class are driven in such a way that they emit their UV radiation with such different radiation powers that the positionally dependent variation of the radiation intensity in the sample plane is compensated for or at least reduced to such an extent that the above-mentioned predefined limits or threshold values are again complied with.

In accordance with one embodiment of the method according to the invention, the spatial position of the UV LEDs within the weathering chamber can be varied. In particular, it can be provided that, during the process of irradiating the sample, individual or all UV LEDs of a class are varied spatially with respect to the sample, that is to say for example are moved to and fro in a specific manner in a lateral direction parallel to the plane of the UV LEDs or perform another type of regular movement such as rotary movement. This can optionally be performed supplementarily to the measures already mentioned, in order to enable a radiation intensity that is as spatially homogeneous as possible within the sample plane during the irradiation process.

In accordance with one embodiment of the method according to the invention, the UV LEDs emit the UV radiation as cw radiation, that is to say with temporally constant radiation power.

In accordance with another embodiment of the method according to the invention, the UV LEDs emit the UV radiation with temporally varying radiation power, that is to say for example in pulsed form with regular pulse trains. This can be provided for example if the situation involves analyzing specific aging effects that are linked to the radiation power in a non-linear manner. This situation may warrant the UV LEDs emitting the shortest possible pulses with the highest possible peak power.

In accordance with one embodiment of the method according to the invention, a plurality of samples are arranged within the weathering chamber in a sample plane provided therefor and are irradiated in parallel with UV radiation from a class of UV LEDs. In accordance with one embodiment of the method according to the invention, the at least one sample is irradiated with a predefined radiation intensity and for a predefined time duration for each of the different emission bands in order in this way to carry out, for example, a weathering test with a time lapse. In this case, it is a general aim to simulate the effect of natural solar radiation as precisely as possible. In the UV range, however, the solar spectrum has a characteristic edge at approximately 300 nm. Consequently, it may be the case that the emission bands of the UV LEDs provided according to the invention lie spectrally in the region of the UV edge and their maxima are thus at wavelengths which are represented with different intensities in the solar spectrum. This fact can be taken into account either by setting the radiation powers of the UV LEDs according to the relations in the solar spectrum or by setting the time durations of the irradiation accordingly, it also being possible to implement both measures.

A device according to the invention for artificially weathering or testing the lightfastness of samples in accordance with a second aspect comprises a weathering chamber, in which a UV radiation device is arranged and at least one sample can be arranged. The UV radiation device contains a plurality of UV light emitting diodes (UV LEDs), comprising UV LEDs of different emission bands. The UV LEDs can be driven in such a way that in each case UV LEDs of a specific emission band can be switched on and off jointly, independently of UV LEDs of the other emission bands.

A UV radiation device according to the invention in accordance with a third aspect comprises a plurality of UV light emitting diodes (UV LEDs) containing two or more classes of UV LEDs of different emission bands, wherein the UV LEDs can be driven in such a way that in each case UV LEDs of a specific emission band can be switched on and off jointly, independently of UV LEDs of the other emission bands.

In accordance with one embodiment of the devices according to the invention, the UV radiation device contains a number of, for example three or more, classes of UV LEDs, wherein within each class the UV LEDs have the same emission characteristic or have the same emission bands of the emitted UV radiation.

In accordance with one embodiment of the devices according to the invention, the totality of the UV LEDs is arranged along the rows and columns of a matrix.

In accordance with one embodiment of the devices according to the invention, the totality of the UV LEDs is arranged in a manner distributed spatially on a planar area, and at least one sample can be arranged in a sample plane spaced apart therefrom. In the sample plane, a receiving area can be present, on which the sample or the samples can be received for example in regions provided therefor. Said regions can be provided in such a way that samples of specific standard sizes can be received therein.

In accordance with another embodiment of the devices according to the invention, the UV LEDs are distributed spatially non uniformly. This can be configured in such a way that the UV LEDs are arranged in the form of clusters of two, three, four or more UV LEDs, in particular in the form of triples, quadruples or n-tuples (n=natural number). These clusters of UV LEDs can then be distributed, for their part, regularly over the area. By way of example, exactly one UV LED from each class of the classes having different emission characteristics can then be represented within each cluster such as each triple or quadruple. In this respect, too, an exemplary embodiment will be shown further below for more detailed explanation.

In accordance with one embodiment of the devices according to the invention, the UV LEDs of a class or of a specific emission band can be driven and/or arranged in a spatially distributed manner in such a way that a predefined positionally dependent radiation intensity whose positionally dependent variation lies within predefined limits or threshold values can be obtained in the sample plane. In this case, it may be provided, in particular, that the UV LEDs of a class or of a specific emission band are arranged in a spatially distributed manner in such a way that a sufficient spatial homogeneity of the radiation intensity within the sample plane can already be obtained with identical radiation powers of the UV LEDs. It may be provided that this applies to all the classes of UV LEDs.

In accordance with one embodiment of the devices according to the invention, the UV LEDs of a class or of a specific emission band are arranged regularly on a planar area. It may be provided that this applies to all the classes of UV LEDs.

In accordance with one embodiment of the devices according to the invention, the UV LEDs are mounted in a spatially variable manner relative to the at least one sample. In particular, either individual UV LEDs or the totality of the UV LEDs can be displaced spatially in relation to the at least one sample for example laterally, i.e. parallel to the sample plane or else perpendicular to the sample plane. It may be provided that any conceivable movement is effected in a regular manner, for instance is effected for example in such a way that the UV radiation device is moved on a closed path.

### BRIEF DESCRIPTION OF THE DRAWINGS

The invention is explained in even greater detail below on the basis of exemplary embodiments in conjunction with the Figures of the drawing, in which:

FIG. 1 shows an exemplary embodiment of a device according to the invention for artificially weathering or testing the lightfastness of samples in a perspective view.

FIG. 2 shows a plan view of a UV radiation device according to the invention containing a plurality of UV LEDs in accordance with one embodiment.

FIG. 3 shows a wavelength-intensity diagram for schematically illustrating the rising edge of the UV component of the solar spectrum and the emission spectra of four UV LEDs.

FIG. 4 shows a plan view of a UV radiation device according to the invention containing a plurality of UV LEDs in accordance with one embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

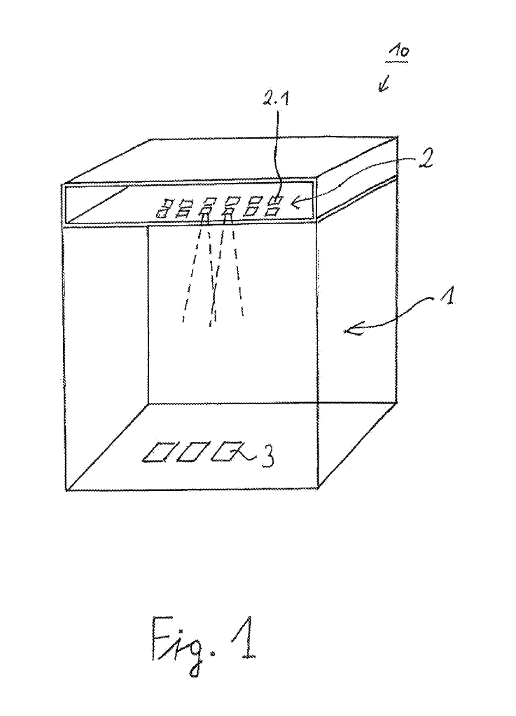

FIG. 1 illustrates schematically in perspective view an embodiment for a device for artificial weathering or testing lightfastness. The device 10 comprises a sample chamber 1, in which a UV radiation device 2 is arranged. In the lower region of the sample chamber 1, suitable mounting means are present on a baseplate, a number of samples 3 being able to be mounted by means of said mounting means. The device is therefore designed as a weathering device with stationary sample mounting. However, the invention can likewise be applied to weathering devices comprising movable sample mounts.

The UV radiation device 2 comprises a plurality of UV LEDs 2.1, which can be mounted along the rows and columns of a matrix on a planar area, such as a circuit board, for example, and can be aligned with regard to their emission characteristic in such a way that the emission radiation is directed perpendicularly downward onto the samples 3 to be examined. In one practicable embodiment, the circuit board with the UV LEDs fixed on the lower surface thereof can be provided as part of an insert cassette that can be inserted into a slot provided therefor on the top side of the device 10. In this case, the circuit board can form a lower base area of the insert cassette, while a cooling medium can flow through the spatial region located thereabove, in order to efficiently dissipate the heat generated by the UV LEDs.

It goes without saying that the device 10 can contain further elements which serve for weathering the samples and are not shown here merely for reasons of simplifying the illustration.

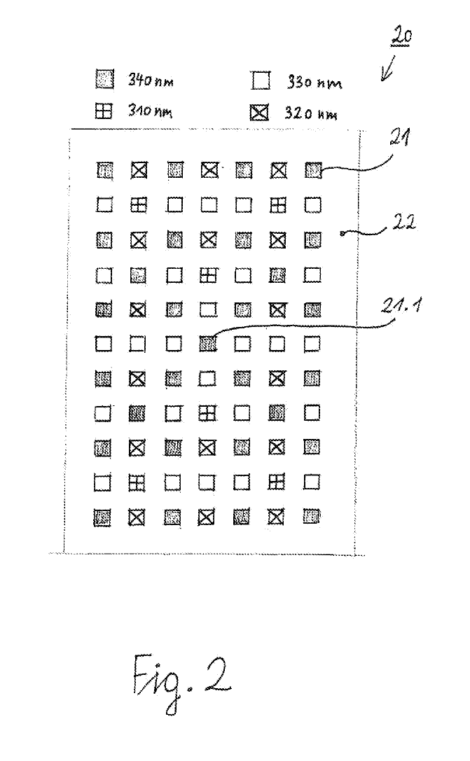

FIG. 2 shows a plan view of a UV radiation device in accordance with one embodiment. The UV radiation device 20 comprises a plurality of UV LEDs 21, which can be arranged along the rows and columns of a matrix and mounted on a planar support 22 such as a circuit board. The plurality of UV LEDs 21 can contain exactly four classes of UV LEDs 21 having different emission bands. These emission bands can be constituted such that the maxima are at wavelengths of 310 nm, 320 nm, 330 nm and 340 nm.

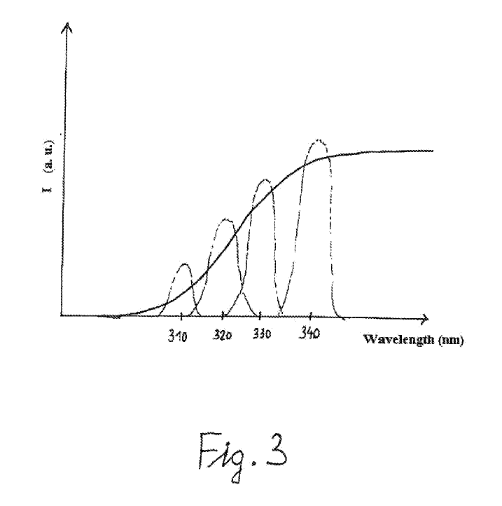

FIG. 3 shows where the emission bands of the four classes of UV LEDs 21 become situated spectrally in relation to the rising edge of the UV component of the solar spectrum. It can be seen that at the wavelength of 310 nm the intensity in the solar spectrum is still at a relatively low level and then at the further wavelengths 320 nm, 330 nm and 340 nm progressively higher intensities are then present in the solar spectrum.

If it is desired to take account of the varying spectral profile within the solar spectrum, then there are basically the following two possibilities. Either the measurements are carried out for the individual emission bands with identical radiation intensities but different time durations of the irradiation or the time durations of the irradiation are identical but the radiation intensities differ between the emission bands. As can be seen with reference to FIG. 3, the latter variant is followed in this embodiment. Of the total of 77 UV LEDs 21 arranged on the circuit board 22, 29 have a wavelength maximum at 340 nm, 26 have a wavelength maximum at 330 nm, 16 have a wavelength maximum at 320 nm and 6 have a wavelength maximum at 310 nm.

Consequently, the UV LEDs at the wavelength of 340 nm, which has the relatively strongest intensity in the solar spectrum, can thus be represented to the highest extent numerically in the UV radiation device 20 and as the wavelength decreases—corresponding to lower intensity in the solar spectrum—the respective number of UV LEDs also decreases.

It can now be provided that the UV LEDs 21 of one class can be switched on and off independently of the UV LEDs of the other classes. If each of the UV LEDs 21 emits with the same radiation power, then the total radiation powers of the classes of UV LEDs are in a ratio to one another such as corresponds relatively well to the ratio of the intensities of the corresponding wavelengths in the solar spectrum. Consequently, in this embodiment, it is possible to carry out examinations on samples in which the samples are individually successively exposed to UV light of the individual classes of UV LEDs 21 and the total irradiation times can be identical to one another.

A further problem to be solved is that with the UV LEDs of each of the four classes that are distributed over an area, an area which is spaced apart at a distance from and is populated with samples 3 can be irradiated with the lowest possible variation of the radiation intensity at the sample plane. This can be achieved in accordance with the embodiment in FIG. 2 by virtue of the fact that the UV LEDs 21 within each of the four classes are arranged regularly on the circuit board 22, the regular arrangement consisting in a point symmetry relative to a central UV LED 21.1. This spatial arrangement makes it possible to achieve a good spatial homogeneity of the radiation intensity at the sample plane. Should there prove to be an excessively high spatial variation of the radiation intensity given identical radiation power of the UV LEDs within a class at specific points on the sample plane, then this can also be compensated for or at least reduced by individual UV LEDs being driven in such a way that they provide a lower or a higher radiation power than the rest of the UV LEDs in the class. For this purpose, it can be provided that the UV LEDs 21 can also be individually regulated.

It is also possible to choose arrangements for UV LEDs 21 that are different from that of the embodiment in FIG. 2. Thus, by way of example, a point-symmetrical arrangement of the UV LEDs 21 of the individual classes can also be chosen in which the point of symmetry is not in a UV LED such as the UV LED 21.1 in FIG. 2, but rather is a point located in an interspace between UV LEDs.

A further alternative embodiment to the arrangement in FIG. 2 could consist in the number of UV LEDs being identical for the four emission bands or classes mentioned, but the individual processes of irradiating the samples being carried out with different total time durations of the irradiation in order in this way to take account of the different spectral intensities of the wavelengths in the solar spectrum.

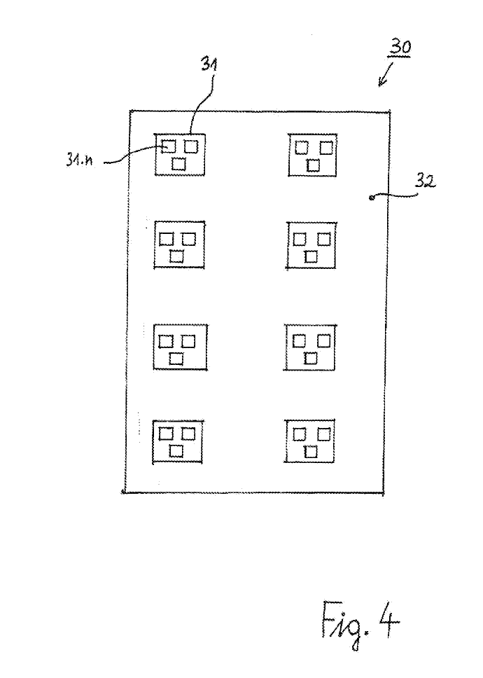

FIG. 4 shows a plan view of a UV radiation device in accordance with one embodiment. The UV radiation device 30 comprises a plurality of UV LEDs 31.n mounted on a planar support 32 such as a circuit board. In contrast to the arrangement in FIG. 2, the UV LEDs 31.n are not distributed spatially identically, but rather are combined in groups 31, wherein the groups 31 can be formed identically. In the exemplary embodiment illustrated, the groups can each contain three UV LEDs 31.n having different UV emission bands. However, the groups can also contain for example in each case only 2 UV LEDs having different emission bands. However, each of the groups can also contain more than three UV LEDs having different UV emission bands, for example four groups having emission bands such as are illustrated in FIG. 3 and are used for the simulation of the UV rising edge of the solar radiation. If appropriate, UV LEDs of specific classes, that is to say having specific UV emission bands, can also be represented multiply in the groups.

It can furthermore be provided that the UV LEDs 31.n within a group are spaced apart from one another in such a way that the distances are negligible relative to the distance between the UV radiation device 30 and the sample plane. This has the consequence that each group 31 taken by itself generates on the sample plane a spectrum which is mixed (“finished”) in the desired manner. The distance between the UV LEDs 31.n can be determined as, for example, an average value of the distances between the mid points of in each case directly adjacent UV LEDs and this distance can be less than 10 times, 50 times or 100 times the distance between the UV radiation device 30 and the sample plane.

Although specific embodiments have been illustrated and described in this description, it is evident to the person skilled in the art that the specific embodiments shown and described can be exchanged for a variety of alternative and/or equivalent implementations, without departing from the scope of protection of the present invention. This application is intended to cover any adaptations or variations of the specific embodiments discussed herein. It is therefore envisaged that this invention is limited only by the claims and the equivalents thereof.

What is claimed is:

1. A method for artificially weathering or testing the lightfastness of samples, comprising:
a. providing a weathering chamber, which contains a ultraviolet radiation device comprising ultraviolet light emitting diodes of different emission bands;
b. arranging at least one sample in the weathering chamber at a distance from the ultraviolet light emitting diodes;
c. irradiating the sample with radiation from at least one ultraviolet light emitting diode of a specific emission band; and
d. the analyzing variations of the sample on account of the irradiation.

2. The method as claimed in claim 1, wherein steps c. and d. are carried out with one or a plurality of ultraviolet light emitting diodes from one or a plurality of further emission bands.

3. The method as claimed in claim 1, wherein in step a. the ultraviolet radiation device for each emission band contains a plurality of ultraviolet light emitting diodes.

4. The method as claimed in claim 3, wherein the plurality of ultraviolet light emitting diodes of an emission band are arranged in such a way and/or are driven in such a way that in the region of the at least one sample a positionally dependent variation of the radiation intensity lies within predefined limits.

5. The method as claimed in claim 4, wherein the ultraviolet light emitting diodes of an emission band are driven in such a way that their radiation powers are different.

6. The method as claimed in claim 4, wherein the ultraviolet light emitting diodes of an emission band are driven in such a way that their radiation powers are identical.

7. The method as claimed in claim 1, wherein in step c. the sample is irradiated with radiation having a temporally constant radiation intensity.

8. A device for artificially weathering or testing the lightfastness of samples, comprising:
a weathering chamber, in which a ultraviolet radiation device is arranged and at least one sample can be arranged, wherein
the ultraviolet radiation device comprises a plurality of ultraviolet light emitting diodes (UV LEDs) containing ultraviolet light emitting diodes of different emission bands, wherein the ultraviolet light emitting diodes can be driven in such a way that in each case ultraviolet light emitting diodes of a specific emission band can be switched on and off jointly, independently of ultraviolet light emitting diodes of the other emission bands.

9. The device as claimed in claim 8, wherein the ultraviolet light emitting diodes are arranged along the rows and columns of a matrix.

10. The device as claimed in claim 8, wherein the ultraviolet light emitting diodes are arranged in a manner distributed spatially on a planar area, and
at least one sample can be arranged in a sample plane spaced apart therefrom.

11. The device as claimed in claim 10, wherein the ultraviolet light emitting diodes of a respective specific emission band can be driven and/or are arranged in a spatially distributed manner in such a way that a predefined positionally dependent radiation intensity whose positionally dependent variation lies within predefined limits can be obtained in the sample plane.

12. The device as claimed in claim 11, wherein the ultraviolet light emitting diodes of a respective specific emission band are arranged in a spatially distributed manner in such a way that the predefined positionally dependent radiation intensity can be obtained with identical radiation powers of the ultraviolet light emitting diodes.

13. The device as claimed in claim 8, wherein the ultraviolet light emitting diodes of a respective specific emission band are arranged regularly.

14. The device as claimed in claim 11, wherein the ultraviolet light emitting diodes are spatially variable.

15. An ultraviolet radiation device, comprising:
a plurality of ultraviolet light emitting diodes ultraviolet light emitting diodes containing two or more classes of ultraviolet light emitting diodes of different emission bands, wherein
the ultraviolet light emitting diodes can be driven in such a way that in each case ultraviolet light emitting diodes of a specific emission band can be switched on and off jointly, independently of ultraviolet light emitting diodes of the other emission bands.
